(19) United States
(12) Patent Application Publication
(10) Pub. No.: US 2014/0152431 A1
(43) Pub. Date: Jun. 5, 2014

(54) VEHICLE SAFEGUARD DEVICE

(71) Applicant: YUEYOU PROTECTOR CO., LTD., NEW TAIPEI CITY (TW)

(72) Inventor: YUE-YOU LIU, NEW TAIPEI CITY (TW)

(73) Assignee: YUEYOU PROTECTOR CO., LTD., NEW TAIPEI CITY (TW)

(21) Appl. No.: 13/690,038

(22) Filed: Nov. 30, 2012

(51) Int. Cl. B60R 25/30

(52) U.S. Cl. CPC B60R 25/30
USPC 340/426.1

(57) ABSTRACT

A vehicle safeguard device includes a setting unit, which is operative to set a vehicle that is in a parked state in a safeguard state; a detection unit, which is electrically connected to the setting unit to detect a horizon state and a signal interrupted state of the vehicle when the vehicle is in the safeguard state; a sensing unit, which receives the horizon state and the signal interrupted state of the vehicle detected by the detection unit; and a signal processing and control unit, which is electrically connected to the sensing unit to receive an abnormality signal of the horizon state and the signal interrupted state of vehicle sensed by the sensing unit and convert the abnormality signal into an alarm signal and transmit the alarm signal to an external management center.

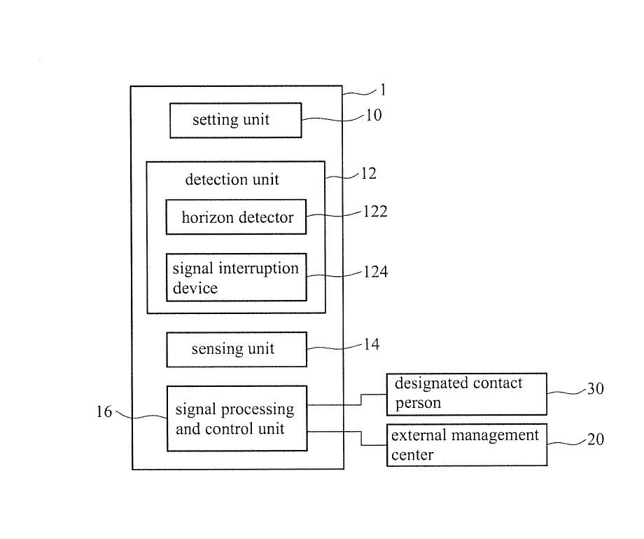

### FIELD OF THE INVENTION

The present invention relates to a vehicle safeguard device, and in particular to a vehicle safeguard device that detects a horizontal state and a signal interrupted state of a vehicle when the vehicle is in a parked condition.

### BACKGROUND OF THE INVENTION

Car theft protection devices are a device that is mounted in a car for the purposes of increasing the difficulty of car stealing and extending the time when car stealing can be completed. With the development of technology, the functionality of the car theft protection device is improving and getting more complete so that the difficulty of stealing car is increased and thefts are not so willing to steal cars and the chance of successful stealing cars gets lower.

Generally, the car theft protection devices are generally classified as mechanical devices, electronic devices, chip based devices, and network based devices. The mechanical theft protection device is generally used to lock and secure for example clutch, transmission, acceleration pedal, steering wheel, and gear shifting level in order to effect theft protection. This kind of theft protection system is bulky and heavy, is inconvenient in use, and can be easily broken. The electronic theft protection system comprises an electronic lock that is remotely controlled to have the car started or shut down when the car door or windows are opened without authorization. This kind of theft protection system generally locks up the car ignition system or start-up system to effect theft protection and is generally advantageous in that installation is generally concealed, the control is effected in a wireless manner, and the operation is easy, but a disadvantage is that the transmission band may be interfered with and cracked.

Further, the chip based digital theft protection system generally locks up motor, circuit, and fuel passage of a car. Without a chip key, there is no way to start the car. This kind of system requires the chip key to contact or insert into a chip lock and thus, the problem of password being scanned and cracked can be avoided. The network based theft protection system is a system that carries out certain functions, such as door opening/closing, motor starting, car interception, car positioning, and car status reporting, through networks, such as GPS positioning and tracking system. However, this kind of theft protection system, although advanced in functionality, is extremely expensive and requires periodical payment of system service fee.

In addition, when the car is parked in a basement or a garage, especially a roofed garage, the GPS positioning and tracking system installed in the car may fail its function, making it impossible to maintain surveillance of the car.

### SUMMARY OF THE INVENTION

A primary object of the present invention is to provide a vehicle safeguard device, which, when a vehicle is set in a standstill state, especially in a parked state, detects abnormality of horizontal state of the vehicle or interruption of a safeguard signal in order to determine if the vehicle is illegally broken in or damaged and to protect the vehicle from theft.

Another object of the present invention is that when the vehicle is set in safeguard, the user of vehicle is allowed to inform an external control center of the parking position of the vehicle through audio voice.

A further object of the present invention is that when the vehicle is in a parked state, a warning light signal of the vehicle must be first removed before the vehicle is set in the safeguard state so that the vehicle can be safeguarded under a normal condition.

Yet a further object of the present invention is that the vehicle safeguard device can monitor an interior space of the vehicle for abnormality in order to issue an alarm message.

To realize the above objects, the present invention provides a vehicle safeguard device, which comprises: a setting unit, which is operative to set a vehicle that is in a parked state in a safeguard state; a detection unit, which is electrically connected to the setting unit to detect a horizon state and a signal interrupted state of the vehicle when the vehicle is in the safeguard state; a sensing unit, which receives the horizon state and the signal interrupted state of the vehicle detected by the detection unit; and a signal processing and control unit, which is electrically connected to the sensing unit to receive an abnormality signal of the horizon state and the signal interrupted state of vehicle sensed by the sensing unit and convert the abnormality signal into an alarm signal and transmit the alarm signal to an external management center.

In an embodiment of the present invention, the setting unit, when setting the vehicle in the safeguard state, transmits an audio voice message to the external management center to inform the center of the parking position of the vehicle.

In an embodiment of the present invention, the detection unit comprises a horizon detector, which detects if the vehicle is in a horizontal condition when the vehicle is set in the safeguard state.

In an embodiment of the present invention, the detection unit comprises a signal interruption device, which detects if a safeguard signal of the vehicle is interrupted when the vehicle is set in the safeguard state.

In an embodiment of the present invention, the vehicle, when in the safeguard state, is also in a fuel passage shutoff state.

In an embodiment of the present invention, the vehicle, when in the safeguard state, is also in a fuel passage non-shutoff state.

The above and other objects and advantages of the present invention will become apparent by reading the following detailed description of an embodiment of the present invention, as well as the attached drawings.

### BRIEF DESCRIPTION OF THE DRAWINGS

The present invention will be apparent to those skilled in the art by reading the following description of a preferred embodiment thereof with reference to the sole drawing:

The FIGURE is a block diagram showing a vehicle safeguard device in accordance with the present invention.

### DETAILED DESCRIPTION OF THE PREFERRED EMBODIMENTS

The present invention aims to provide a vehicle safeguard device, which, when the vehicle is in a parked condition, detects a horizontal state and a signal interrupted state of the vehicle to determine if the vehicle is stolen. For throughout understanding of the present invention, detailed steps and compositions of the present invention will be described. However, although detailed descriptions will be given to the preferred embodiments of the present invention, beyond such details, the present invention may be further and widely applied to other embodiments. It is understood that the scope of the present invention is not limited by the embodiments but is instead defined by the appended claims.

Referring first to the FIGURE, the FIGURE is a block diagram showing a vehicle safeguard device according to the present invention. In the FIGURE, the vehicle safeguard device is generally designated at 1 and comprises a setting unit 10, a detection unit 12, a sensing unit 14, and a signal transmission and control unit 16. The setting unit 10 functions to set a vehicle that is in a parked state to a safeguard state. In the present invention, when an enabling control unit (not shown), such as vehicle key slot (not shown) is in a shutdown position, the dashboard (not shown) of the vehicle may display at least one trouble signal. Thus, the user, who wishes to activate the vehicle safeguard device, must first remove the trouble signal so displayed before the vehicle safeguard device can operate to set the vehicle in the safeguard state. The trouble signal can be for example window or skylight being not closed, door being not closed, trunk lid or hood being not closed, or light (headlight or fog light) being not turned off and thus, the vehicle user must eliminate or correct such troubles to have the trouble signal displayed on the dashboard of the vehicle removed and then the vehicle safeguard device can be activated to set the vehicle in the safeguard state; otherwise, the vehicle safeguard device cannot be activated. This arrangement helps remind the user that the safeguarding is set in a condition when the vehicle is in an unsecured condition and vehicle stealing may easily occur.

Further, when the vehicle is already in the parked state, the vehicle user must identify if the slope of the ground where the vehicle is parked is excessive. The vehicle user may visual check if slope alarm indictors installed inside the vehicle are lit after the vehicle has been parked but the vehicle safeguard device is not activated yet. When the slope alarm indicators of the vehicle are lit, it indicates that the slope of the ground where the vehicle is parked is excessive and the vehicle must be otherwise parked at location where the slope of the ground is not excessive; alternatively, the slope alarm indicators circuit associated with the lit alarm indicators can be switched through conversion switches provided inside the vehicle, of which the purpose is to set the slope alarm indicators associated with the lit alarm indicators back to a normal situation. Once the circuit gets normal, the slope alarm indicators go off and the vehicle user is allowed to normally activate the vehicle safeguard device to set the vehicle in the safeguard state. For example, when the vehicle is parked and the slope alarm indicators inside the vehicle show “0101”, the sign “0101” indicates that the vehicle is in a state of normal slope angle and setting of the vehicle can be carried out with the vehicle safeguard device. If the slope alarm indicators inside the vehicle show “1010”, this is a sign of abnormality and switching must be carried out with the conversion switches provided inside the vehicle to switch the abnormality signal “1010” back to the normality sign “0101”, which sets the vehicle in a normal condition where setting of the vehicle can be done with the vehicle safeguard device.

Further, in the present invention, when a user sets the vehicle in the safeguard state, the user of the vehicle may transmit audio voice message to an external management center 20 to advise the parking location of the vehicle.

Further, the vehicle safeguard device 1 further comprises a detection unit 12 and is electrically connected to the setting unit 12. The detection unit 12 is operative to detect a horizontal state and a signal interrupted state of the vehicle when the vehicle is in the safeguard state. In the present invention, the detection unit comprises a horizon detector 122 and a signal interruption device 124. The horizon detector 122 is operative to detect if the vehicle takes a horizontal displacement as being acted upon by an external force. Here, the horizon detector 122 may also detect variation of vibration of the vehicle. When the vehicle, which was in a parked state, generates abnormal vibration, such as the vehicle being impacted by an external force, the horizon detector 122 can detect the vibration of the vehicle. The signal interruption device 124 is operative to detect the interruption of signal after the vehicle safeguard device has been activated. For example, with the vehicle being in the safeguard state, the trunk lid, hood, or widows of the vehicle are forcibly opened by an external force, the signal interruption device 124 may detect the interruption of signal of the vehicle in the safeguard state.

Further, in the present invention, when the vehicle is in the safeguard state, the vehicle can be also in a fuel passage shutoff state or a fuel passage non-shutoff state, wherein a circuit (not shown) is operative to control a pump in an activated state or a shutdown state so as to selectively set the vehicle that is in the safeguard state in a fuel passage shutoff state or a fuel passage non-shutoff state.

The sensing unit 14 is operative to receive the abnormality signals of the vehicle horizon state and signal interruption state detected by the detection unit 12. The sensing unit 14 transmits the received abnormality signals to the signal processing and control unit 16. Further, the sensing unit 14 of the present invention is also operative to sense abnormality occurring in the internal space of the vehicle through microwave sensing. When the vehicle is in the safeguard state, when a foreign object invades the interior space of the vehicle, the sensing unit 14 senses the abnormality in the interior space of the vehicle and the sensing unit 14 transmits the abnormality signal to the signal processing and control unit 16.

The signal processing and control unit 16 is electrically connected to the sensing unit 14 to receive, in the way described above, the abnormality signals of the sensing unit 14, such as abnormal change of horizon of the vehicle, signal interruption, and/or abnormal condition inside the vehicle, so as to convert the abnormality signal into an alarm signal and transmit the alarm signal to the external management center 20. The external management center 20 may then contact the police department to inform the police department of the abnormal condition of the vehicle.

Further, in the present invention, when the vehicle safeguard device 1 is released from safeguard in a normal condition, the vehicle safeguard device 1 simultaneously notifies a designated contact person 30 that safeguarding of the vehicle is being currently released.

As such, with the vehicle safeguard device according to the present invention, when the vehicle safeguard device is activated and the vehicle is set in the safeguard state, a theft protection indicator (not shown) that is additionally installed in the vehicle may persistently light to allow the vehicle user to indentify if the vehicle is currently set in the safeguard state. When the vehicle is subjected to horizontal displacement, such as the tires being damaged, the vehicle being towed and moved, vibration being caused by unidentified impact with unknown external forces, and hood, trunk lid, windows, or skylight being violently opened, the detection unit 12 of the vehicle safeguard device 1 according to the present invention may detect such an abnormality signal and transmits the abnormality signal to the sensing unit 14 so that the sensing unit 14 may forward the signal to the signal processing and control unit 16 for transmission of such an abnormality signal to an external management center which may notify the police department of such a situation and at the same time advise the vehicle user of the detection of abnormality of the vehicle to thereby achieve the function of safeguarding the vehicle.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A vehicle safeguard device, comprising:
a setting unit, which is operative to set a vehicle that is in a parked state in a safeguard state;
a detection unit, which is electrically connected to the setting unit to detect a horizon state and a signal interrupted state of the vehicle when the vehicle is in the safeguard state;
a sensing unit, which receives the horizon state and the signal interrupted state of the vehicle detected by the detection unit; and
a signal processing and control unit, which is electrically connected to the sensing unit to receive an abnormality signal of the horizon state and the signal interrupted state of vehicle sensed by the sensing unit and convert the abnormality signal into an alarm signal and transmit the alarm signal to an external management center.

2. The vehicle safeguard device as claimed in claim 1, wherein the setting unit, when setting the vehicle in the safeguard state, transmits an audio voice message to the external management center.

3. The vehicle safeguard device as claimed in claim 1, wherein the detection unit comprises a horizon detector, which detects if the vehicle is in a horizontal condition when the vehicle is set in the safeguard state.

4. The vehicle safeguard device as claimed in claim 1, wherein the detection unit comprises a signal interruption device, which detects if a safeguard signal of the vehicle is interrupted when the vehicle is set in the safeguard state.

5. The vehicle safeguard device as claimed in claim 1, wherein the vehicle, when in the safeguard state, is also in a fuel passage shutoff state.

6. The vehicle safeguard device as claimed in claim 1, wherein the vehicle, when in the safeguard state, is also in a fuel passage non-shutoff state.
